(19) United States
(12) Patent Application Publication
(10) Pub. No.: US 2020/0412182 A1
(43) Pub. Date: Dec. 31, 2020

(54) MOTOR

(71) Applicant: Nidec Corporation, Kyoto (JP)

(72) Inventors: Yukinobu Shiraishi, Kyoto (JP); Yusuke Watanabe, Kyoto (JP); Yuya Horii, Kyoto (JP)

(21) Appl. No.: 16/904,616

(22) Filed: Jun. 18, 2020

(30) Foreign Application Priority Data
Jun. 28, 2019 (JP) 2019-122047

(51) Int. Cl. H02K 1/16; H02K 3/48; H02K 3/12; H02K 3/28

(52) U.S. Cl. CPC H02K 1/165; H02K 3/28; H02K 3/12; H02K 3/48

(57) ABSTRACT

A stator core includes a core back and teeth. The core back has an annular shape surrounding the central axis. The teeth extend radially from the core back and are arranged in the circumferential direction. The coil is defined by a conductive wire wound around the tooth. A coil group includes at least one U-phase coil, at least one V-phase coil, and at least one W-phase coil that are circumferentially arranged in a predetermined order. The core back includes support portions and linking portions. The support portions connect the teeth defining each coil group. The linking portions link the adjacent support portions. The support portion has a lower magnetic resistance per unit length in the circumferential direction than that of the linking portion.

### CROSS REFERENCE TO RELATED APPLICATION

The present application claims priority under 35 U.S.C. § 119 to Japanese Application No. 2019-122047 filed on Jun. 28, 2019 the entire contents of which are hereby incorporated herein by reference.

### 1. FIELD OF THE INVENTION

The present disclosure relates to a motor.

### 2. BACKGROUND

A conventional motor includes, for example, a stator core and coils. The stator core is formed by arranging small cores at regular intervals in the circumferential direction. The small core includes a plurality of teeth arranged radially, and a core back that connects bases of the teeth. Adjacent small cores are connected via an insulating member. The coil is formed by winding a conductive wire around a tooth.

However, in the conventional motor, adjacent core backs are connected via an insulating member, and the magnetic flux flowing in the circumferential direction along the core back hardly flows in the insulating member, so that the magnetic characteristics of the entire stator core may be reduced.

### SUMMARY

A motor according to an example embodiment of the present disclosure includes a rotary assembly and a stationary assembly. The rotary assembly is rotatable about a central axis extending vertically. The stationary assembly rotationally drives the rotary assembly. The stationary assembly includes a stator core and coils. The stator core includes a core back and teeth. The core back has an annular shape surrounding the central axis. The teeth extend radially from the core back and are arranged in the circumferential direction. The coil is defined by a conductive wire wound around the tooth. Further, coil groups each including at least one U-phase coil, at least one V-phase coil, and at least one W-phase coil, in which these coils are arranged in a predetermined order in the circumferential direction, are provided. The core back includes a plurality of support portions and linking portions. The support portion is defined by a magnetic body that connects teeth defining each coil group. The linking portion is defined by a magnetic body that links the adjacent support portions. The support portion has a smaller magnetic resistance per unit length in the circumferential direction than that of the linking portion.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view of a vertical cross section of a motor according to a first example embodiment of the present disclosure.

FIG. 2 is a perspective view showing a stationary assembly of the motor according to the first example embodiment of the present disclosure.

FIG. 3 is an example of a connection diagram of coils of the motor according to the first example embodiment of the present disclosure.

FIG. 4 is a top cross-sectional view of a stationary assembly of the motor according to the first example embodiment of the present disclosure.

FIG. 5 is a top view of a stator core of a motor according to a second example embodiment of the present disclosure.

FIG. 6 is a sectional view taken along line X1-X1 in FIG. 5.

FIG. 7 is a top view of a stator core of a motor according to a third example embodiment of the present disclosure.

FIG. 8 is a sectional view taken along line X2-X2 in FIG. 7.

FIG. 9 is a top view of a stator core of a motor according to a fourth example embodiment of the present disclosure.

FIG. 10 is a sectional view taken along line X3-X3 in FIG. 9.

### DETAILED DESCRIPTION

Hereinafter, example embodiments of the present disclosure will be described in detail with reference to the drawings. In the present specification, a direction parallel to the central axis of a motor is referred to as an “axial direction”, a direction orthogonal to the central axis of the motor is referred to as a “radial direction”, and a direction along the arc with the central axis of the motor being the center is referred to as a “circumferential direction”. In the present application, the shape and positional relationship of each part will be described with the axial direction being the vertical direction and the circuit board side with respect to the stator core being a lower side. Note that the vertical direction is simply a name used for description, and does not limit the actual positional relationship and direction.

In the present disclosure, a “parallel direction” includes a substantially parallel direction. In addition, in the present disclosure, an “orthogonal direction” includes a substantially orthogonal direction.

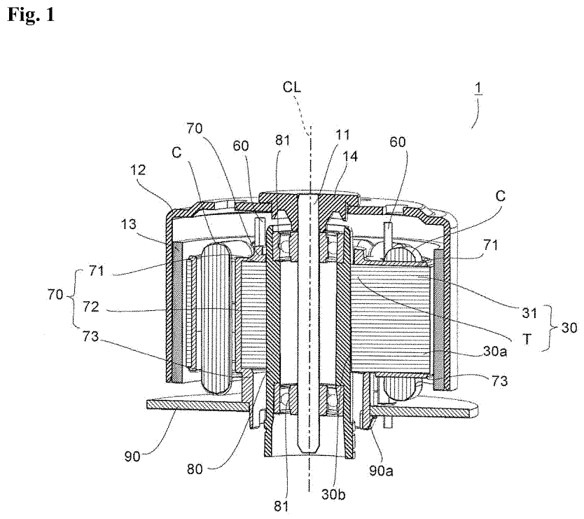

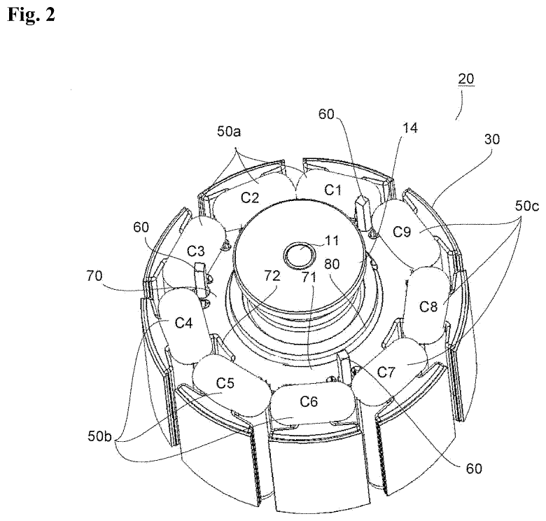

A motor according to an example embodiment of the present disclosure will be described. FIG. 1 is a perspective view of a vertical cross section of a motor 1 according to a first example embodiment of the present disclosure, and FIG. 2 is a perspective view of a stationary assembly 20.

The motor 1 includes a rotary assembly 10 and a stationary assembly 20. The rotary assembly 10 is rotatable about a central axis CL extending vertically. The stationary assembly 20 drives the rotary assembly 10 to rotate. The rotary assembly 10 includes a shaft 11, a rotor holder 12, a rotor magnet 13, and a joint 14. The shaft 11 is a columnar metal member that rotates about the central axis CL extending vertically. The rotor holder 12 is in a cylindrical shape with a cover, and is connected to the upper end of the shaft 11 via the joint 14. The rotor magnet 13 is fixed to an inner surface of the rotor holder 12, and is disposed to face radially outside of the stationary assembly 20. The rotor magnet 13 may be fixed to the inner surface of the rotor holder 12 via, for example, an annular rotor core provided to the inner surface of the rotor holder 12. The rotor core has a plurality of magnet insertion holes arranged in the circumferential direction, and the rotor magnet 13 is inserted in the magnet insertion hole.

The stationary assembly 20 includes a stator core 30, a coil C, a conductor (terminal pin) 60, an insulator 70, a bearing holder 80, and a circuit board 90. In the present example embodiment, the terminal pin 60 is used as a conductor, but another conductor may be used.

The stator core 30 is formed in an annular shape having a press-fit hole 30b penetrating in the axial direction on the central axis CL. The stator core 30 is formed by axially stacking a plurality of core members 30a each formed of a magnetic material such as an annular electromagnetic steel plate. At this time, for example, the core members 30a adjacent in the axial direction are caulked and joined. The core members 30a adjacent in the axial direction may be joined by welding.

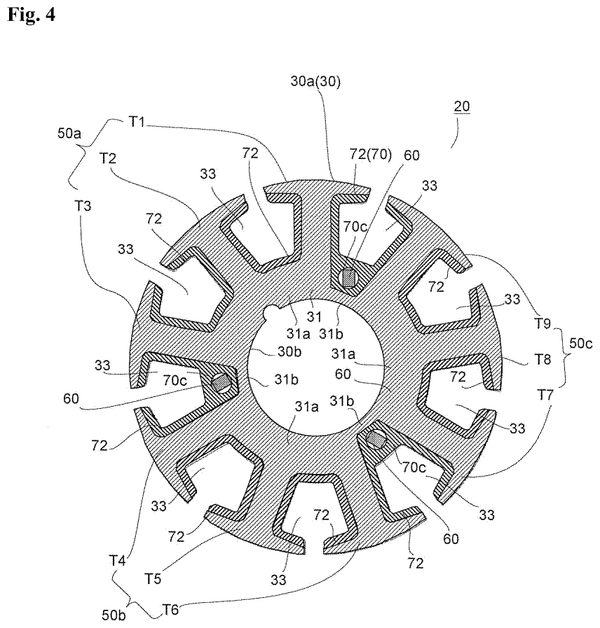

The stator core 30 has a core back 31 and teeth T (see FIG. 4). The core back 31 and the teeth T are formed integrally. The core back 31 surrounds the central axis CL and is formed in an annular shape. The press-fit hole 30b is formed by stacking the radially inner surface of the core back 31 in the axial direction. The teeth T extend radially outward from the radially outer surface of the core back 31, and are arranged at equal intervals in the circumferential direction. For example, the number of teeth T in the present example embodiment is nine.

The insulator 70 is made of an insulative resin molded product, and has an upper surface cover portion 71, a side surface cover portion 72, and a lower surface cover portion 73. The upper surface cover portion 71 covers the upper surface of the stator core 30. The lower surface cover portion 73 covers the lower surface of the stator core 30. Further, the side surface cover portion 72 may be divided in the axial direction, and may be formed integrally with the upper surface cover portion 71 and with the lower surface cover portion 72, respectively. The detailed configuration of the side surface cover portion 72 will be described later.

The coil C is formed by winding a conductive wire (not shown) around the tooth T via the insulator 70. That is, the insulator 70 is interposed between the conductive wire and the tooth T. The insulator 70 insulates the stator core 30 from the conductive wire. In the following description, the coils C arranged in the circumferential direction will be denoted by reference numerals C1 to C9. The coils C1 to C9 are arranged in the circumferential direction in the order of U phase, V phase, and W phase. That is, the coils C1, C4, and C7 are in the U phase. The coils C2, C5, and C8 are in the V phase. The coils C3, C6, and C9 are in the W phase.

Further, coil groups 50a, 50b, and 50c are respectively formed of a plurality of coils C. The coil groups 50a, 50b, and 50c are arranged in order in the circumferential direction. In each of the coil groups 50a, 50b, and 50c, a U-phase coil, a V-phase coil, and a W-phase coil are arranged in order in the circumferential direction. The coil group 50a includes the coils C1, C2, and C3. The coil group 50b includes the coils C4, C5, and C6. The coil group 50c includes the coils C7, C8, and C9. That is, in the stationary assembly 20, a plurality of coil groups 50a, 50b, and 50c are formed, each including at least one U-phase coil, at least one V-phase coil, and at least one W-phase coil which are arranged in a predetermined order in the circumferential direction.

The terminal pins 60 each extend in the axial direction, and are arranged between the coils C1 and C9 in the circumferential direction, between the coils C3 and C4 in the circumferential direction, and between the coils C6 and C7 in the circumferential direction, respectively. Note that the arrangement of the terminal pins 60 in the present example embodiment is an example, and the positions of the terminal pins 60 differ depending on the number of teeth T and the configuration of the coil groups 50a, 50b, and 50c. The lower end of the terminal pin 60 is soldered to the circuit board 90.

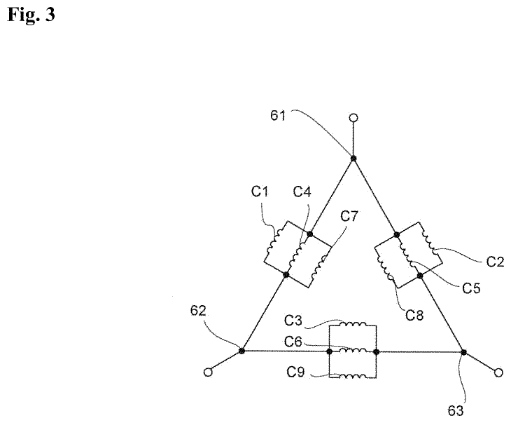

FIG. 3 shows an example of a connection diagram of the coils C1 to C9. The coils C in the same phase are connected in parallel. The terminal pins 60 have connecting portions 61, 62, and 63. The connecting portions 61, 62, and 63 are arranged at the upper ends of the terminal pins 60, and are connected to the conductive wires forming the coils C1 to C9, respectively.

The circuit board 90 has a board insertion hole 90a. The board insertion hole 90a is disposed at a position axially overlapping the central axis CL, and penetrates the circuit board 90 in the axial direction.

The bearing holder 80 is formed in a cylindrical shape, and holds a bearing portion 81 inside. The bearing portion 81 rotatably supports the shaft 11. For the bearing portion 81, for example, a rolling bearing is used. The bearing holder 80 is inserted into the board insertion hole 90a of the circuit board 90, and is pressed into the press-fit hole 30b of the stator core 30.

FIG. 4 is a top cross-sectional view of the stationary assembly 20 in which the coil C, the bearing holder 80, and the circuit board 90 are omitted. Further, the teeth T arranged at positions corresponding to the coils C1 to C9 described above will be described with reference numerals T1 to T9.

The core back 31 of the stator core 30 includes support portions 31a and linking portions 31b. The support portion 31a connects the teeth T1, T2 and T3 forming the coil group 50a with each other. Further, the support portion 31a connects the teeth T4, T5, and T6 forming the coil group 50b with each other. Further, the support portion 31a connects the teeth T7, T8, and T9 forming the coil group 50c with each other. The linking portion 31b links the adjacent support portions 31a. The support portion 31a has a larger width in the radial direction than that of the linking portion 31b, and has a smaller magnetic resistance per unit length in the circumferential direction.

The side surface cover portions 72 of the insulator 70 are arranged between the adjacent teeth T1 to T9, respectively, and extend in the axial direction along the stator core 30. The side surface cover portion 72 includes a first cover portion 72a that covers the radially outer surface of the core back 31, and a second cover portion 72b that covers the circumferential outer surface of the tooth T. Inside the side surface cover portion 72, a slot 33 formed of the space between the adjacent teeth T1 to T9 is formed.

The first cover portions 72a are formed to be thicker in the radial direction between the teeth T1 and T9 in the circumferential direction, between the teeth T3 and T4 in the circumferential direction, and between the teeth T6 and T7 in the circumferential direction, compared with those between the teeth T1 and T2 in the circumferential direction, between the teeth T2 and T3 in the circumferential direction, between the teeth T4 and T5 in the circumferential direction, between the teeth T5 and T6 in the circumferential direction, between the teeth T7 and T8 in the circumferential direction, and between the teeth T8 and T9 in the circumferential direction.

Further, the first cover portions 72a have insulator insertion holes 70c respectively between the teeth T1 and T9 in the circumferential direction, between the teeth T3 and T4 in the circumferential direction, and between the teeth T6 and T7 in the circumferential direction. The insulator insertion hole 70c extends axially, and the terminal pin 60 is inserted therein.

That is, the terminal pin 60 is disposed radially outside the linking portion 31b in opposition to the linking portion 31b. The insulator 70 has the side surface cover portion 72 that covers the radially outer surface of the linking portion 31b, and the insulator insertion hole 70c that is disposed in the side surface cover portion 72 and into which the terminal pin 60 is inserted.

Here, the radial length of the linking portion 31b is shorter than the radial length of the support portion 31a. For this reason, even if the radial thickness of the side surface cover portion 72 is formed to be larger radially outside the linking portion 31b, the space of the slot 33 is not narrowed. Therefore, it is possible to prevent reduction of the number of turns of the conductive wire that can be wound in the slot 33 disposed radially outside the linking portion 31b. In addition, since the radial thickness of the side surface cover portion 72 that covers the radially outer surface of the linking portion 31b is formed to be larger, the insulator insertion hole 70c can be arranged in the side surface cover portion 72. Therefore, in the slot 33 in which the insulator insertion hole 70c is arranged, it is possible to prevent reduction of the number of turns of the conductive wire that can be wound. Thereby, the driving efficiency of the motor 1 can be improved.

When a drive current is applied to the coils C1 to C9, magnetic flux is generated in the teeth T1 to T9. As a result, a circumferential torque is generated between the teeth T and the rotor magnet 13. As a result, the rotary assembly 10 rotates about the central axis CL with respect to the stationary assembly 20.

At this time, the magnetic flux generated in the coil C passes radially inward through the teeth T, and advances in the circumferential direction along the inner peripheral portion of the core back 31. Here, the support portion 31a and the linking portion 31b are made of a magnetic material, and can reduce magnetic flux loss. Therefore, a decrease in the magnetic characteristics of the entire stator core 30 can be reduced.

Moreover, the support portion 31a connecting the teeth T forming the coil groups 50a to 50c has a greater effect of losing the magnetic flux generated by each of the coil groups 50a to 50c than the linking portion 31b. Therefore, by making the magnetic resistance per unit length in the circumferential direction of the support portion 31a smaller than that of the linking portion 31b, the magnetic flux loss in the entire stator core 30 can be reduced. Here, since the terminal pin 60 is arranged in opposition to the linking portion 31b having a small width in the radial direction, it is possible to suppress a magnetic flux loss and secure a wide slot 33.

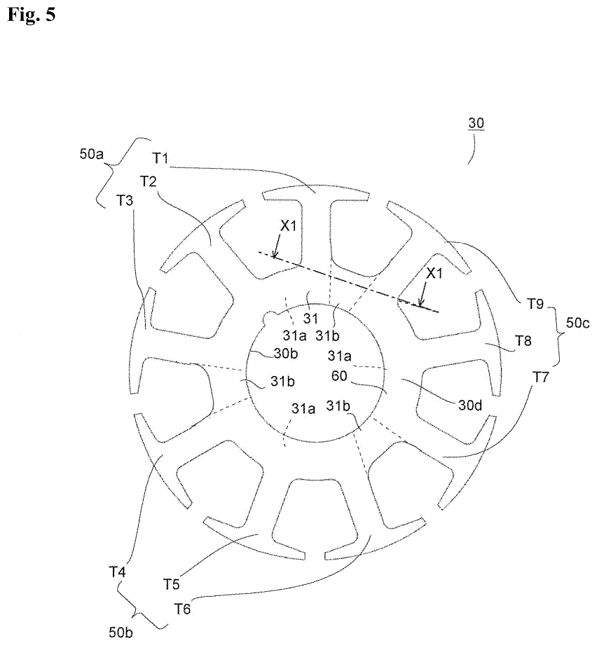

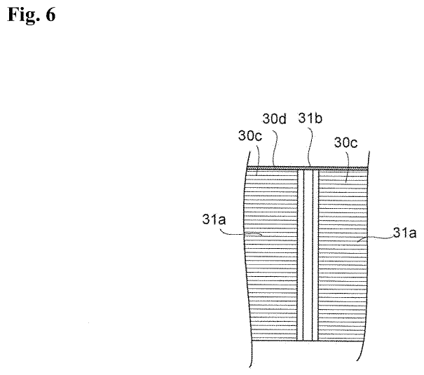

Next, a second example embodiment of the present disclosure will be described. FIG. 5 is a top view of a stator core 30, and FIG. 6 is a sectional view taken along line X1-X1 in FIG. 5. For convenience of explanation, the same parts as those in the first example embodiment shown in FIGS. 1 to 4 are denoted by the same reference numerals. In the second example embodiment, the shape of the stator core 30 is different from that of the first example embodiment. Other parts are the same as those in the first example embodiment.

The stator core 30 is formed of a core member 30c made of an electromagnetic steel plate and a connection member 30d made of an electromagnetic steel plate. The core member 30c includes support portions 31a and three teeth T corresponding to each of the support portions 31a. A plurality of core members 30c are stacked in the axial direction. Thereby, each support portion 31a is formed in an arc shape in plan view.

The three support portions 31a arranged in the circumferential direction are stacked on the annular connection member 30d. Here, the linking portion 31b is formed by the connection member 30d between the support portions 31a, and the support portion 31a has a larger axial thickness than that of the linking portion 31b. Thus, the support portion 31a has a smaller magnetic resistance per unit length in the circumferential direction than that of the linking portion 31b. Therefore, advantageous effects similar to those of the first example embodiment can be obtained.

Further, regarding the arc-shaped core member 30c constituting the support portion 31a, the amount that can be formed by being punched from a single electromagnetic steel sheet can be increased, as compared with the annular core member 30a of the first example embodiment in which the support portion 31a and the linking portion 31b are integrally formed. Therefore, the manufacturing cost of the stator core 30 can be reduced.

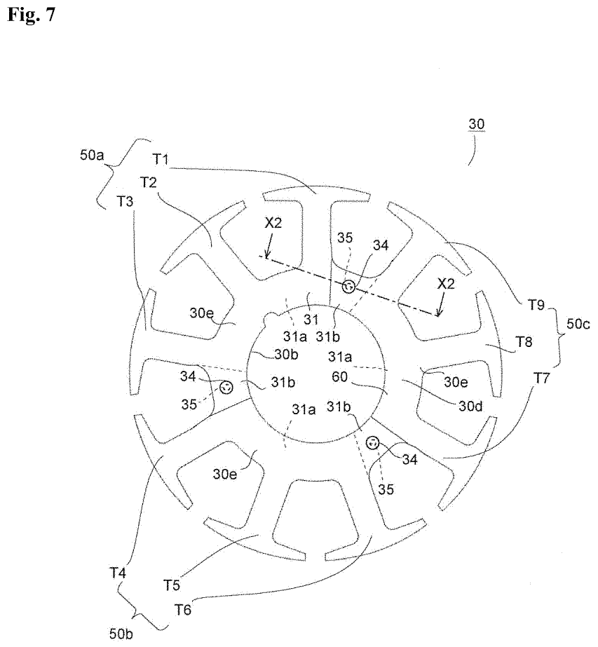

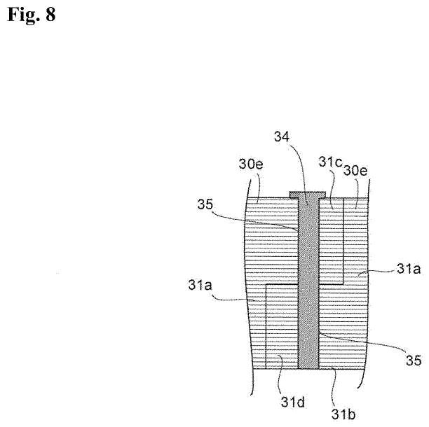

Next, a third example embodiment of the present disclosure will be described. FIG. 7 is a top view of a stator core 30, and FIG. 8 is a cross-sectional view taken along line X2-X2 in FIG. 7. For convenience of explanation, the same parts as those in the second example embodiment shown in FIGS. 5 and 6 are denoted by the same reference numerals. In the third example embodiment, the shape of the stator core 30 is different from that of the second example embodiment. The other parts are the same as in the second example embodiment.

The stator core 30 is divided in the circumferential direction. The stator core 30 is formed by stacking a plurality of core members 30e each made of an electromagnetic steel plate in the axial direction. The core member 30e includes support portions 31a and three teeth T corresponding to each of the support portions 31a. Thereby, each support portion 31a is formed in an arc shape in plan view.

The core back 31 is divided in the circumferential direction on the linking portion 31b. The linking portion 31b includes a first extending portion 31c, a second extending portion 31d, a through-hole 35, and a fixing portion 34. The first extending portion 31c extends circumferentially from one axially upper portion of the adjacent support portion 30a. The second extending portion 31d extends circumferentially from the other axially lower portion. The first extending portion 31c and the second extending portion 31d are stacked in the axial direction. The through-hole 35 axially penetrates the first extending portion 31c and the second extending portion 31d that are stacked in the axial direction.

The fixing portion 34 is formed of a nonmagnetic material such as aluminum or brass, and extends in the axial direction and is formed in a rod shape. The fixing portion 34 is inserted in the through-hole 35. Thereby, the first extending portion 31c and the second extending portion 31d are connected by the fixing portion 34. Therefore, the adjacent support portions 31a are linked by the linking portion 31b. The fixing portion 34 has a higher magnetic resistance than that of the electromagnetic steel plate forming the support portion 31a. Thus, the support portion 31a has a smaller magnetic resistance per unit length in the circumferential direction than that of the linking portion 31b. Therefore, the same advantageous effects as those in the second example embodiment can be obtained.

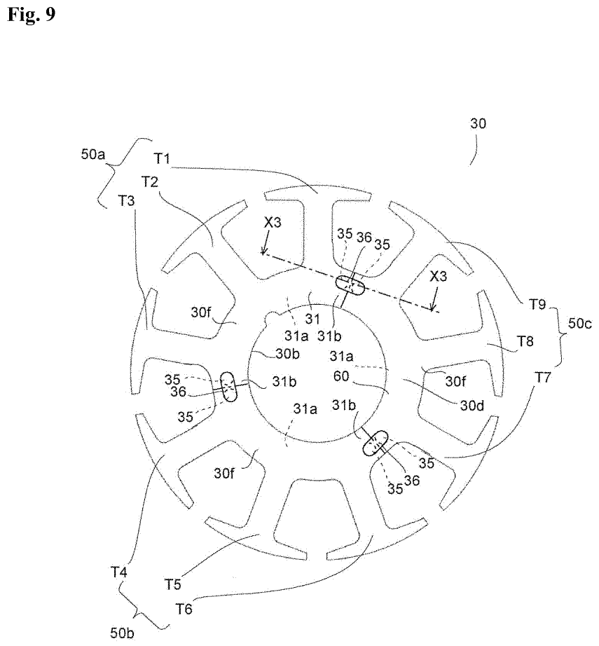

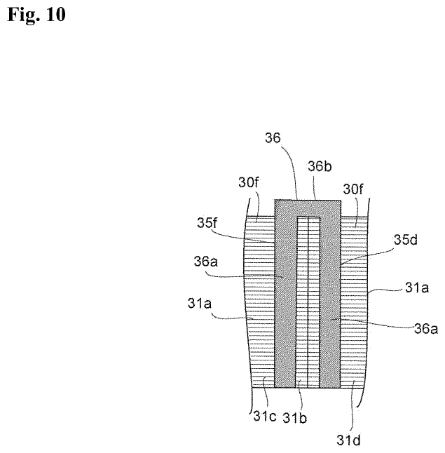

Next, a fourth example embodiment of the present disclosure will be described. FIG. 9 is a top view of a stator core 30, and FIG. 10 is a cross-sectional view taken along line X3-X3 in FIG. 9. For convenience of explanation, the same parts as those in the third example embodiment shown in FIGS. 7 and 8 are denoted by the same reference numerals. In the fourth example embodiment, the shape of the stator core 30 is different from that of the third example embodiment. The other parts are the same as those in the third example embodiment.

The stator core 30 is divided in the circumferential direction. The stator core 30 is formed by axially stacking a plurality of core members 30f each made of an electromagnetic steel plate. The core member 30f includes support portions 31a and three teeth T corresponding to each of the support portion 31a. Thereby, each support portion 31a is formed in an arc shape in plan view.

The core back 31 is circumferentially divided on the linking portion 31b. The linking portion 31b has a first extending portion 31c and a second extending portion 31d. The first extending portion 31c extends circumferentially from one of the adjacent support portions 30a, and the second extending portion 31d extends circumferentially from the other. A first through-hole 35a penetrating in the axial direction is formed in the first extending portion 31c. A second through-hole 35b penetrating in the axial direction is formed in the second extending portion 31d.

Further, the linking portion 31b has a fixing portion 36 formed of a non-magnetic material such as aluminum or brass. The fixing portion 36 has a pair of legs 36a and a connecting portion 36b. The leg 36a is formed in a rod shape extending in the axial direction. The connecting portion 36b extends in the circumferential direction, and both ends are connected to the upper portions of the legs 36a respectively. The axial thickness of the linking portion 31b is formed to be substantially the same as the axial thickness of the support portion 31a.

The first extending portion 31c and the second extending portion 31d are arranged with the first through-hole 35a and the second through-hole 35b being arranged in the circumferential direction, and are connected by the fixing portion 36. Therefore, the adjacent support portions 31a are linked by the linking portion 31b. The fixing portion 36 has a higher magnetic resistance than that of the electromagnetic steel sheet forming the support portion 31a. Therefore, the support portion 31a has a smaller magnetic resistance per unit length in the circumferential direction than that of the linking portion 31b. Therefore, the same advantageous effects as those of the third example embodiment can be obtained.

The above example embodiments are merely examples of the present disclosure. The configuration of the example embodiments may be appropriately changed without departing from the technical idea of the present disclosure. The example embodiments may be implemented in combination as far as possible.

The motor of the present disclosure is applicable to, for example, a vehicle-mounted cooling blower.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotary assembly rotatable about a central axis extending vertically; and
a stationary assembly that rotationally drives the rotary assembly; wherein
the stationary assembly includes:
a stator core including a core back in an annular shape surrounding the central axis, and a plurality of teeth extending radially from the core back and arranged in a circumferential direction; and
a coil defined by a conductive wire wound around each of the teeth;
a plurality of coil groups are provided, each of the plurality of the coil groups including, among a plurality of the coils, at least one coil in a U-phase, at least one coil in a V-phase, and at least one coil in a W-phase that are arranged in a predetermined order in the circumferential direction;
the core back includes:
a plurality of support portions defined by a magnetic body linking the teeth defining each of the coil groups; and
a linking portion defined by a magnetic body linking the support portions adjacent to each other; and
the support portion has a smaller magnetic resistance per unit length in a circumferential direction than a magnetic resistance of the linking portion.

2. The motor according to claim 1, wherein the support portion has a radial width that is larger than a radial width of the linking portion.

3. The motor according to claim 2, wherein
the stationary assembly includes a conductor that is connected to the conductive wire and extends in an axial direction; and
the conductor is radially outside the linking portion in opposition to the linking portion.

4. The motor according to claim 3, wherein
the stationary assembly includes an insulator interposed between the conductive wire and the teeth; and
the insulator includes:
a side surface cover portion that covers a radially outer surface of the linking portion; and
an insulator insertion hole that is provided to the side surface cover portion and in which the conductor is inserted.

5. The motor according to claim 1, wherein the support portion has a thickness in an axial direction that is larger than a thickness of the linking portion.

6. The motor according to claim 1, wherein
the core back is divided in the circumferential direction on the linking portion; and
the linking portion includes:
a first extending portion extending in the circumferential direction from one of the support portions adjacent to each other;
a second extending portion extending in the circumferential direction from another one of the support portions adjacent to each other; and
a fixing portion that connects the first extending portion and the second extending portion.

7. The motor according to claim 6, wherein
the first extending portion extends in the circumferential direction from an axially upper portion of the support portion;
the second extending portion extends in the circumferential direction from an axially lower portion of the support portion; and
the fixing portion is inserted in a through-hole axially penetrating the first extending portion and the second extending portion stacked in the axial direction.

8. The motor according to claim 6, wherein
the linking portion includes:
a first through-hole axially penetrating the first extending portion; and
a second through-hole axially penetrating the second extending portion; and
the fixing portion includes:
a pair of legs inserted into the first through-hole and the second through-hole; and
a connection portion that connects the pair of legs.

9. The motor according to claim 6, wherein the fixing portion is made of a non-magnetic material.
